(19) United States
(12) Patent Application Publication
(10) Pub. No.: US 2009/0101176 A1
(43) Pub. Date: Apr. 23, 2009

(54) METHOD AND APPARATUS FOR CARRYING OUT A CLEANING PROCESS

(75) Inventor: Oliver NOHYNEK, St. Gallen (CH)

Correspondence Address: THE MAXHAM FIRM, 9330 SCRANTON ROAD, SUITE 350, SAN DIEGO, CA, 92121, US

(73) Assignee: DRIAM ANLAGENBAU GmbH, Eriskirch (DE)

(21) Appl. No.: 12/271,673

(22) Filed: Nov. 14, 2008

Related U.S. Application Data
(63) Continuation of application No. PCT/EP2007/004251, filed on May 14, 2007.

(30) Foreign Application Priority Data
May 15, 2006 (DE) 102006022897.9

(51) Int. Cl. B08B 9/032

(52) U.S. Cl. 134/22.12; 134/52

(57) ABSTRACT

A method for carrying out a cleaning process in coating systems. Such a coating system comprises a horizontally, rotationally mounted drum container for receiving the product which is to be coated and polygonal and perforated lateral areas which are sealingly covered, respectively, by an air duct. The invention also relates to a device for carrying out the method. The invention is characterised in that a cleaning lance, which can be displaced axially, automatically passes through the air duct arranged on the outer wall of the drum container for cleaning and/or drying, and it cleans and/or dries the inner wall of the air duct.

### FIELD OF THE INVENTION

The invention generally relates to a method and a device for carrying out a cleaning process of air ducts in a drum coating system.

### BACKGROUND OF THE INVENTION

Coatings of solid bodies, such as tablets, utilizing a further active ingredient are widely used in the pharmaceutical and food industries. In order to carry out such a coating process of, for example, tablets, in a continuous production process, it is known to carry out such coating processes by means of a drum coating system. Such a drum coating system has a pivotably driven, horizontally supported drum body, the lateral area of which is embodied in a polygonal manner. Mixing vanes or the like are preferably arranged on the inner walls of the drum body, which are embodied according to the specific production process. On the non-driven side of the drum body the same has an opening that is preferably utilized for the entry and exit of the product.

The coating system has air ducts on the lateral areas of the drum body that is embodied in a polygonal manner, which are utilized for introducing process air into the interior of the drum during the coating process. Furthermore, such air ducts are utilized for an upstream or downstream cleaning process also being carried out using process air. For this purpose the arranged air ducts are associated with a respectively configured air conducting system guiding the respective process air into the air ducts for cleaning, which is subsequently introduced into the interior of the drum container via perforated lateral areas.

Such an air conducting system is preferably embodied for blowing process air in and out via the air ducts, wherein the air conducting system has a respective division of a suctioning or blowing side, respectively, blowing or suctioning off the process air. The entire drum and air conducting system is attached to a base frame on a vertically arranged base plate having a support frame arranged behind the same.

The cleaning process represents a substantial effort in such a production process. It is necessary in the said drum coating systems that all of the product and active ingredient carrying system parts are respectively cleaned after the coating process in order to prevent intermixing and/or blending of products with different active ingredients in subsequent production processes. Depending on the use of the utilized active ingredient the degree of contamination of the inner walls and perforations of the drum housing, and of the inner walls of the air ducts arranged on the outer walls of the drum housing is accordingly high. Therefore it has been necessary to partially disassemble the product or active ingredient carrying system parts and to subject them to a respective cleaning process.

One disadvantage of such a cleaning process is that the disassembly/assembly of the product or active ingredient carrying system parts is relatively time consuming and high in costs. Until now this problem has been partially solved in that the same type of products having the same type of active ingredients have been produced as far as possible in such a drum coating system in order to keep the cleaning process of the coating system as time and cost effective as possible. Due to the manifold product range in the pharmaceutical and food industry, however, it is necessary that such drum coating systems are used for production processes that change rapidly and involve the production of different products using different active ingredients in the coating method.

### SUMMARY OF THE INVENTION

The invention, as represented by embodiments described herein, is directed to an improved method for cleaning product and active ingredient carrying system parts of a coating system such that a substantially time and cost effective cleaning process is achieved.

In accordance with an embodiment of the invention, a cleaning lance, which can be displaced axially, automatically passes through the air duct being arranged on the outer walls of the drum container, and cleaning and/or drying the inner walls of the air duct.

The method provides a substantial advantage over the prior art in that the product or active ingredient carrying system parts of a coating system no longer have to be disassembled, or re-assembled, respectively, in a time consuming and costly manner for cleaning purposes. The arrangement of a cleaning lance therefore provides an advantage that the inner walls of the air duct contaminated by active ingredients are automatically cleaned of both the active ingredients and any solid body contaminants formed by means of a respective cleaning lance that can be axially displaced.

Furthermore, embodiments of the invention provide a substantial advantage due to the axially displaceable cleaning lance process air is also applied to the drum interior after the coating process for the purpose of drying the inner walls, since the process air flows in via the perforated polygonal lateral areas of the drum container.

However, the cleaning method described herein is not limited to cleaning using process air. Instead, other cleaning agents may also be used in other assembly states, such as cleaning gases, liquids, liquids containing solid particles, among others.

A preferred embodiment of the invention provides that an axially displaceable cleaning lance is driven in a horizontal alignment according to the horizontally arranged air channels in an electro-mechanical manner. This electro-mechanical drive displaces the cleaning lance in an axial direction into the air duct that is also arranged in the axial direction, and sprays the process air into the air duct via a nozzle arranged at the end of the cleaning lance, and into the perforations in the lateral area of the drum housing.

The cleaning process can be carried out in a repeated manner by means of changing the direction of the axial displacement of the cleaning lance, until the contaminations have been removed from the air duct and from the perforations in the lateral area. Furthermore, the process air injected via the air duct flows into the interior of the drum container via the perforated drum lateral area, thus also carrying out a cleaning and drying process of the drum interior.

A further embodiment of the invention provides that an axially displaceable cleaning lance is inserted directly into the drum container interior via a respective opening in order to carry out targeted cleaning of the drum inner surfaces using the mixing vanes or mixing systems, respectively, attached thereto.

Both embodiments are therefore characterized in that substantial cost and time savings can be achieved for such cleaning processes in coating systems by means of this automated cleaning process. At the same time this cleaning process may be further shortened by means of the arrangement of a plurality of cleaning lances.

### BRIEF DESCRIPTION OF THE DRAWING

The invention is more fully explained by the following detailed description of advantageous embodiments of the same, reference being made to the appended drawing figures, in which:

FIG. 1 is a perspective main view of a coating system having an arranged cleaning lance in accordance with the invention;

FIG. 2 is a perspective, partially cut away illustration of a coating system having a cleaning lance in use in accordance with the invention; and

FIG. 3 is a partial sectional illustration of the electro-mechanical drive of the cleaning lance of FIG. 2.

### DETAILED DESCRIPTION OF THE PREFERRED EMBODIMENTS

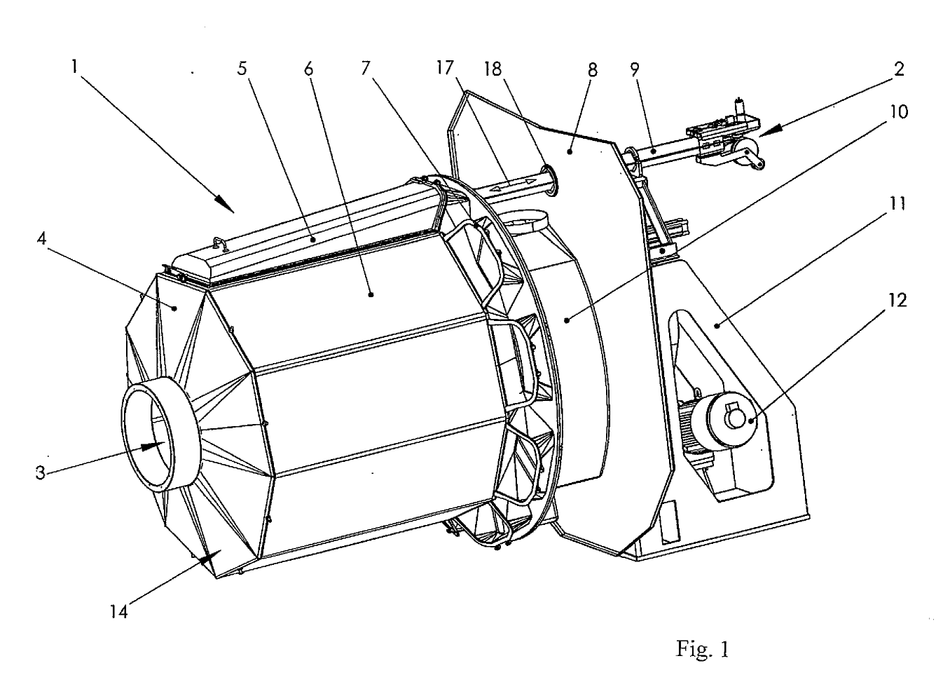

Coating system 1 is illustrated in FIG. 1, showing that a vertically arranged support frame 11 is attached to a schematically illustrated machine rack, which in turn is connected to a laminar frame plate. An air conducting system 10 arranged in a displaceable manner perpendicular to frame plate 8, wherein the air conducting system interacts with the drum adapter being horizontally arranged on the base plate. Horizontally arranged drum 14 of the coating system has a lateral area that is embodied in a polygonal manner, which is perforated. Air duct 5 is positioned in an arrangement opposite of this perforated, polygonal lateral area 6 of drum 14, which is shown connected to air conducting system 10 via adapter 7.

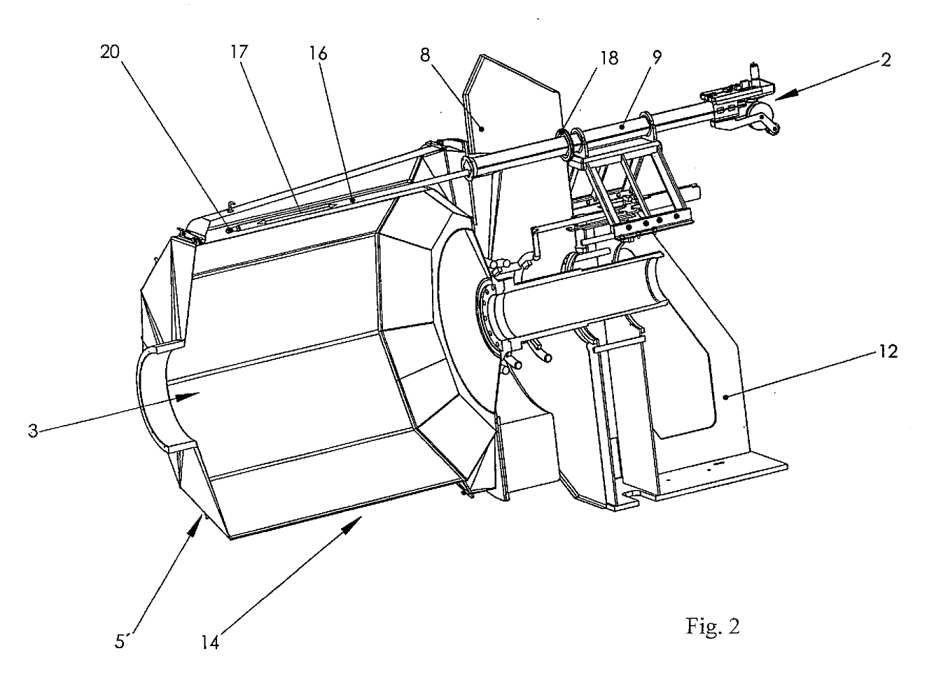

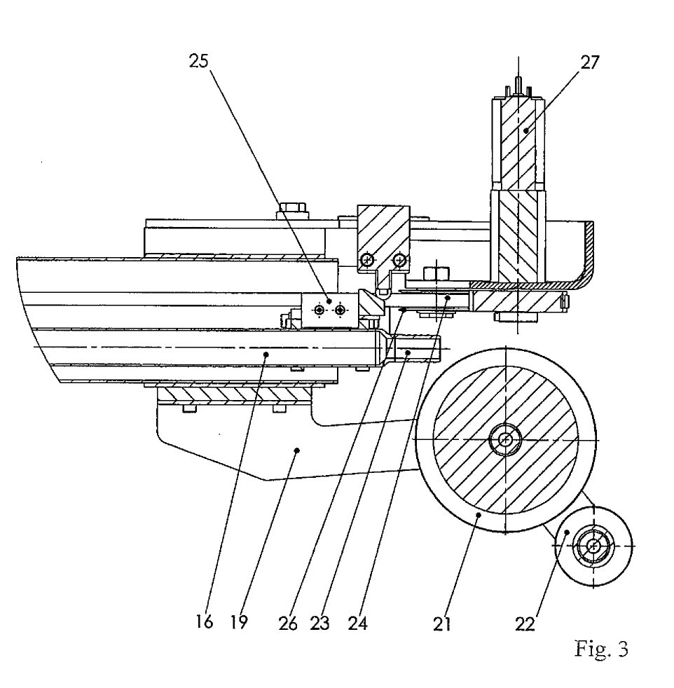

A cleaning system according to the invention is arranged in the upper region of frame plate 8, which is arranged in an axially aligned manner to the longitudinal axis of air duct 5. Protective conduit 9 of the cleaning system is held both by means of being supported in frame plate 8 and by means of a counter bearing respectively arranged in a horizontal alignment. Electro-mechanical drive 2 is arranged in the opposite direction of air duct 5 for driving cleaning lance 16 (see FIGS. 2 and 3).

Once the cleaning method for cleaning the product or active ingredient carrying system parts is initiated, drum 14, together with air duct 5 arranged on the drum lateral area 6, assumes a position opposite of cleaning lance 16 (see FIG. 2). Subsequently the electro-mechanical drive moves the cleaning lance into air duct 5 in axial direction 17.

Cleaning lance 16, being displaceable back and forth in axial direction 17, has a nozzle head on the front free end thereof, by means of which the process air is injected under pressure into the interior of air duct 5.

The embodiment of such a nozzle 20 depends on the degree of contamination, or on the geometric embodiment of the space to be cleaned. For example, rotary nozzles, cone nozzles, spray nozzles, flat stream nozzles, or the like, may be used for such cleaning methods.

The repeating back and forth movement of cleaning lance 16 in axial direction 17 can be repeated any number of times, and is controlled by means of respective control means via system controls.

Subsequent to the cleaning process cleaning lance 16 is moved back and forth in protective conduit 9 in axial direction 17, and is therefore disengaged from the interior of air duct 5. Then drum 14 carries out a rotating pivoting movement until a further air duct 5 arranged on lateral area 6 of drum 14 is located in an opposite position of the cleaning lance. Now the cleaning process is repeated as described above.

In a further embodiment of the cleaning system of the invention, a protective conduit 9, a cleaning lance 16 having an electro-mechanical drive 2, is arranged on frame plate 8 such that cleaning lance 16 can be displaced into the interior of drum 14 in axial direction via a respective opening. This embodiment is not illustrated in further detail herein, as it is based on the same cleaning method using a similar cleaning system.

The coating system illustrated in FIG. 2 clearly shows that the cleaning lance 16 of the cleaning system according to the invention is axially displaced into the interior of air duct 5 and carries out a cleaning process. Due to the pressure, the process air injected via the nozzle 20 flows into the interior of the drum via the perforated drum lateral area 6 and also carries out a cleaning or drying process in that location. Due to the division of air conducting system 10 into a blowing and a suctioning side, the process air injected into the interior of drum 14 is suctioned off from the suction side of air conducting system 10 via air duct 5′ arranged on the opposite side. In this manner the cleaning method forms a nearly closed circuit.

The arrangement of the cleaning system according to the invention is provided in the upper region of air conducting system 10 according to the construction design, wherein continuous recess 18 is embodied in base plate 8 for supporting the protective conduit 9 of the cleaning system.

This air conducting system is embodied as a static system (non-rotational) in coating system 1 as shown.

FIG. 3 illustrates electro-mechanical drive 2 from FIGS. 1 and 2 according to the invention for cleaning lance 16 of a cleaning system according to the invention of coating system 1. Together with carriage 25, cleaning lance 16 comprises a positive-fit connection, wherein the carriage is attached to a pivot-driven toothed belt 24 by means of clamping via an associated clamping plate (not illustrated in detail) in a form-fitting manner. Toothed belt 24 is pivot-driven by drive 27 as a transmission drive via toothed belt disk 26. According to the drive arrangement, cleaning lance 16 according to the invention is displaced in axial direction 17 in and out of the opposite air duct 5 on drum lateral area 6 of drum 14 in the coating system.

The cleaning agent is supplied to the cleaning lance by means of hose connection 23 on the back end of the same via a hose line (not illustrated in detail). In order to prevent entanglement of the arranged hose line the cleaning system has a fixture 28 on the electro-mechanical drive 2, on which two deflection rollers 21 and 22 are pivot-supported and serve for the deflection of the hose line. Preferably, the hose line is conducted downward in the direction of the machine rack 13, and is further loaded by a weight. The weight (not illustrated in detail) prevents an interfering length of hose line being located in the area of the axially displaceable cleaning lance 16.

Exemplary embodiments have been described for disclosure purposes and not by way of limiting the scope of the invention. The invention is to be limited only by the scope of the claims appended hereto and their reasonable equivalents.

What is claimed is:

1. A method for carrying out a cleaning process in coating systems comprising a horizontally pivot-supported drum container comprising perforated lateral areas embodied in a polygonal manner for receiving the products to be coated, each being covered by an air duct in a sealing manner, and having a cleaning lance, the method comprising;
axially displacing the cleaning lance with respect to a selected air duct; and
automatically passing process fluid by means of the cleaning lance selectively through an air duct arranged on the outer walls of the drum container.

2. The method according to claim 1, and further comprising cleaning the selected air duct and the inner walls of the drum container by means of process air.

3. The method according to claim 1, and further comprising drying the selected air duet and the inner walls of the drum container by means of process air.

4. The method according to claim 2, wherein the axially displaceable cleaning lance has a nozzle on the free end thereof, and further comprising injecting the cleaning agent onto the inner walls of the air duct.

5. The method according to claim 1, and further comprising:
injecting the cleaning agent into the air duct through the axially displaceable cleaning lance; and
cleaning the inner walls of the drum container by flowing the cleaning agent into the drum container via perforated drum lateral areas arranged underneath.

6. The method according to claim 2, and further comprising:
injecting the cleaning agent into the air duct through the axially displaceable cleaning lance; and
cleaning the inner walls of the drum container by flowing the cleaning agent into the drum container via perforated drum lateral areas arranged underneath.

7. The method according to claim 1, and further comprising utilizing cleaning agents of different assembly states for the cleaning process, such as liquids, liquid containing solid particles, gases, or the like, with the cleaning lance.

8. The method according to claim 1, and further comprising displacing the cleaning lance in the axial direction by control means.

9. The method according to claim 2, and further comprising displacing the cleaning lance in the axial direction by control means.

10. The method according to claim 1, and further comprising:
gradually pulsing the pivoting movement of the drum container for cleaning or drying the air ducts and the inner walls of the drum container; and
adjusting the pulse to the arrangement of the cleaning lance.

11. The method according to claim 2, and further comprising:
gradually pulsing the pivoting movement of the drum container for cleaning or drying the air ducts and the inner walls of the drum container; and
adjusting the pulse to the arrangement of the cleaning lance.

12. A device for carrying out a cleaning process in coating systems, wherein the coating system has a horizontally pivot-supported drum container comprising perforated lateral areas embodied in a polygonal manner for receiving the product to be coated, the device comprising:
an air duct covering each lateral area in a sealing manner; and
an axially displaceable cleaning lance configured to automatically pass fluid through the air duct arranged on the outer walls of the drum container and the inner walls of the drum container for cleaning and/or drying the inner walls of the air duct.

13. The device according to claim 13; and further comprising:
a frame plate; and
a protective conduit arranged on the frame plate for the cleaning lance, wherein the cleaning lance is arranged in the air duct arranged on top on the drum container in an automatically displaceable manner.

14. The device according to claim 13, and further comprising:
an electro-mechanical drive coupled to the cleaning lance for displacing the cleaning lance in the axial direction;
a toothed belt;
a carriage to which the cleaning lance is firmly connected, the carriage having a positive-fit connection to the toothed belt for driving the carriage in the axial direction; and
machine controls having control means for driving the carriage.

15. The device according to claim 13, and further comprising:
a hose connection arranged at the back end of the cleaning lance;
a hose line connected to the back end of the cleaning lance; and
deflection rollers to maintain the hose line kink and buckle free to provide a supply of cleaning agent to the cleaning lance.
